(19) United States
(12) Patent Application Publication
(10) Pub. No.: US 2015/0042579 A1
(43) Pub. Date: Feb. 12, 2015

(54) INFORMATION PROCESSING APPARATUS AND PROGRAM

(71) Applicant: TOSHIBA TEC KABUSHIKI KAISHA, Tokyo (JP)

(72) Inventor: Hajime Tomizawa, Shizuoka-ken (JP)

(21) Appl. No.: 14/333,568

(22) Filed: Jul. 17, 2014

(30) Foreign Application Priority Data
Aug. 8, 2013 (JP) 2013-164784

(51) Int. Cl. G06F 3/041

(52) U.S. Cl. CPC G06F 3/041
USPC 345/173

(57) ABSTRACT

According to one embodiment, an information processing apparatus includes a touch panel display and a control unit. The control unit performs a control of the touch panel display, in which when the touch panel display receives an operation of bringing one of plural images displayed on the touch panel display into contact with another image, the two images are integrally displayed and are integrally operated.

### CROSS-REFERENCE TO RELATED APPLICATION

This application is based upon and claims the benefit of priority from Japanese Patent Application No. 2013-164784, filed Aug. 8, 2013, the entire contents of which are incorporated herein by reference.

### FIELD

Embodiments described herein relate generally to a technique to control a display and an operation on a touch panel.

### BACKGROUND

There is a computer in which a multi-touch panel for detecting plural touches is adopted as an input device. Besides, there is a tabletop computer in which this touch panel is further enlarged and is adopted as a table top. The tabletop computer allows a large number of people to simultaneously perform operation and hold a meeting and a presentation.

The user brings a fingertip or a pen tip into contact with an image area displayed on the touch panel and causes sliding movement. The image is moved by this operation. Besides, plural fingertips or pen tips are brought into contact with an image and a specified gesture operation is performed, so that the rotation, enlargement, reduction or the like of the image can be performed.

When the number of displayed images increases in the computer including the touch panel as stated above, the images are respectively scattered and are disordered.

Embodiments described herein have been made to solve the problems described above, and an object thereof is to provide a technique for suppressing scattering of displayed images.

### DESCRIPTION OF THE DRAWINGS

FIG. 1 is a view showing an outer appearance of a tabletop information processing apparatus according to an embodiment.

FIG. 2 is a diagram showing a hardware configuration example of the tabletop information processing apparatus according to the embodiment.

FIG. 3 is a diagram in which the tabletop information processing apparatus according to the embodiment is seen from above.

FIG. 4 is a diagram showing a display example of the tabletop information processing apparatus according to the embodiment.

FIG. 5 is a diagram showing a data configuration example of content information.

FIG. 6 is a diagram showing an example of information stored in a DRAM.

FIG. 7 is a flowchart showing an operation example when contents are associated with each other.

FIG. 8 is a diagram of a data configuration example representing the associated state of contents stored in the DRAM.

FIG. 9 is a diagram showing a display example when the association is completed.

FIG. 10 is a diagram showing an operation example when the association is released.

FIGS. 11A to 11C are diagrams showing a state where plural contents are associated and are diagrams showing an operation example when the display order is changed.

FIG. 12 is a flowchart (No. 1) showing an operation example according to the embodiment.

FIG. 13 is a flowchart (No. 2) showing the operation example according to the embodiment.

### DETAILED DESCRIPTION

In general, according to one embodiment, an information processing apparatus includes a touch panel display and a control unit. When the touch panel display receives an operation of bringing one of plural images displayed on the touch panel display into contact with another image, the control unit controls so that the two images are integrated and displayed, and are integrated and operated.

According to one embodiment, an information processing apparatus includes following functions.

Plural images or documents (hereinafter, these displayed images are referred to as contents) are displayed on a touch panel display, and arbitrary contents are respectively moved, rotated, enlarged and reduced by a multi-touch operation.

The contents can be associated with each other, and are grouped and displayed. The contents respectively have attribute information, and contents associated with a certain content are classified by attribute or are sorted and displayed. The associated contents are integrated and displayed on the touch panel, and the operation of movement, rotation, enlargement and reduction is integrally performed.

The association of the contents can be released.

Based on the attribute information, control is performed as to whether or not the association is possible, and contents which can not be associated with each other are not integrally displayed and operated.

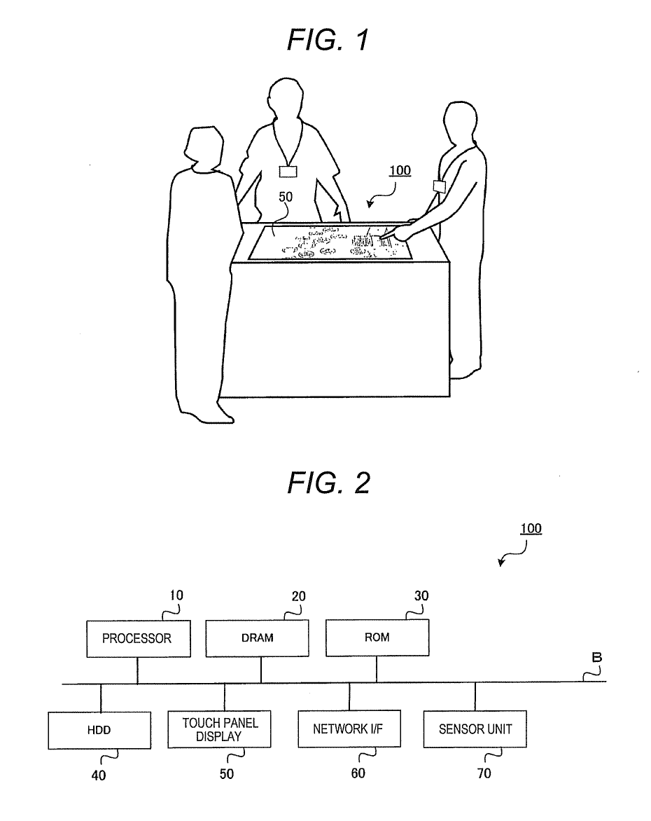

Hereinafter, an exemplary embodiment will be described with reference to the drawings. FIG. 1 is a diagram showing an outer appearance of a tabletop information processing apparatus according to the embodiment. A tabletop information processing apparatus 100 is a table type (tabletop) information processing apparatus, and a large touch panel display 50 for operation and display is arranged on a top plate surface.

In the touch panel display 50, a multi-touch sensor (input unit) for simultaneously detecting plural touch positions is laminated and arranged on a panel type display unit, and an image on a screen can be controlled by a fingertip or a pen tip. The touch panel display 50 can display various content images, and has a function as a user interface for operation input;

FIG. 2 is a block diagram showing an example of an inner hardware configuration of the tabletop information processing apparatus 100. The tabletop information processing apparatus 100 includes a processor 10, a DRAM (Dynamic Random Access Memory) 20, a ROM (Read Only Memory) 30, a HDD (Hard Disk Drive) 40, a touch panel display 50, a network I/F (Interface) 60 and a sensor unit 70. These mutually transmit and receive control signals and data through a communication bus B.

The processor 10 is an arithmetic processing device such as a CPU (Central Processing Unit), and performs various processes in accordance with programs by loading the programs stored in the ROM 30 or the HDD 40 into the DRAM 20 and by executing an arithmetic operation. The DRAM 20 is a volatile main storage device. The ROM 30 is a nonvolatile storage device for permanent storage, and stores BIOS (Basic Input Output System) used at system start-up and the like. The HDD 40 is a nonvolatile auxiliary storage device capable of storing permanently, and stores data and programs used by a user.

The touch panel display 50 includes an input unit of a touch panel and a display unit of a flat panel. The touch panel supports multi-touch to detect plural simultaneous touches, and can obtain coordinate values (x value, y value) corresponding to the touch position. The flat panel includes light-emitting elements for display on the whole panel surface.

The network I/F 60 is a unit configured to communicate with an external equipment, and includes a LAN (Local Area Network) board. Besides, the network I/F 60 includes a device based on a short-distance radio communication standard and a connector based on a USB (Universal Serial Bus) standard.

The sensor unit 70 includes after-mentioned sensors 70A to 70D, and is a unit which detects an ID (Identification) card owned by a user, and reads information stored in the ID card. The read information is used for log-in authentication of the tabletop information processing apparatus 100. The ID card is a non-contact type IC card and stores at least identification information of the user.

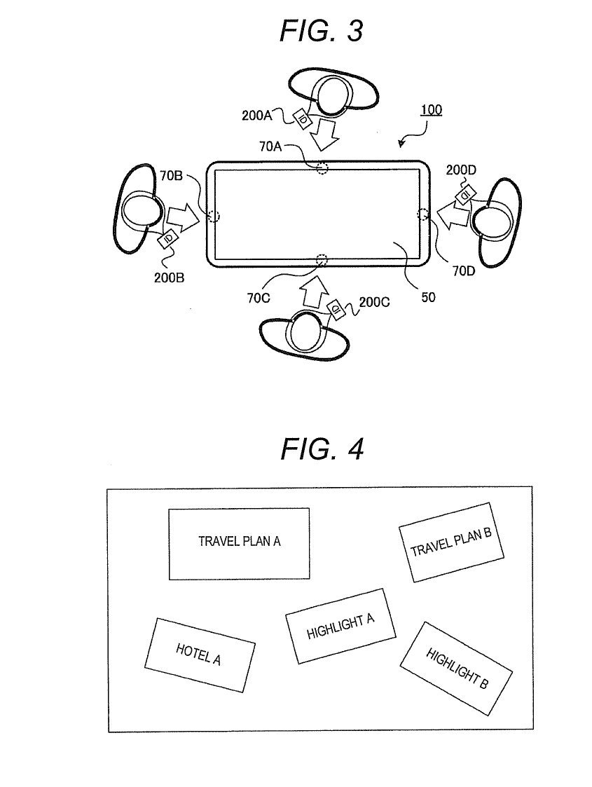

FIG. 3 is a plan view in which the tabletop information processing apparatus 100 is seen from above. The tabletop information processing apparatus 100 enables plural users to simultaneously log in. In this example, the sensors 70A to 70D included in the sensor unit 70 are respectively arranged at centers of four side surfaces near the top plate. When users carrying ID cards 200A to 200D approach the sensors 70A to 70D, the sensor unit 70 reads the information in the ID card, and log-in authentication is performed. If the information in the ID card is one previously registered in the HDD 40 or an external authentication mechanism, the authentication is judged as being acceptable.

The tabletop information processing apparatus 100 displays a screen for performing a meeting or the like to the authenticated user. The user performs document edition, browsing of data and home pages, and the like on this screen. These displayed contents can be moved, enlarged, reduced, rotated, selected or deleted by a specified user's operation by using a well-known technique.

The processor 10 executes a program previously stored in the HDD 40, so that the tabletop information processing apparatus 100 realizes a content display function. FIG. 4 shows a state where plural contents are displayed by the content display function. In the example of FIG. 4, data relating to travel plans in a travel agent are displayed as contents.

A travel plan A and a travel plan B indicating information such as an itinerary and a price are displayed on the touch panel display 50. Besides, the touch panel display 50 shows a highlight A and a highlight B indicating pictures and information of highlights visited in the itinerary, and a hotel A indicating a picture and information of a hotel visited in the itinerary. The user browses and operates the contents displayed on the touch panel display 50, selects one of the travel plan A and the travel plan B, and determines the highlight visited in the itinerary.

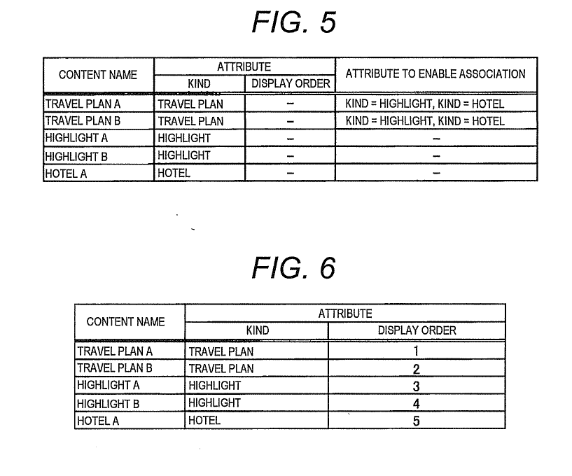

Next, management of contents will be described. Content information in which information relating to the contents is defined is previously stored in the HDD 40. FIG. 5 shows an example of the content information. As shown in FIG. 5, the content information is information in which records including content names, attribute information and attributes to enable association are listed. The content name is information to uniquely identify the content. The kind in the attribute information indicates a kind to which the content belongs, and in this example, the kinds of travel plan, highlight and hotel are included. A display order is numerical data indicating the display order when the contents are displayed. Since the display order is not permanently stored in the HDD 40, nothing is defined in FIG. 5. The attribute information is used when the contents are classified as described later, or the contents are sorted and displayed. The attribute to enable association are described later.

The content information is stored in the HDD 40 of the tabletop information processing apparatus 100. When the contents are displayed, as shown in FIG. 6, the processor 10 copies the content name and the attribute information into the DRAM 20, and manages them as renewable attribute information. The display order as one of the attributes is set by the processor 10 in order of display of the contents. For example, when the travel plan A, the hotel A and the highlight A are displayed in this order, the display order of the travel plan A is 1, the display order of the hotel A is 2, and the display order of the highlight A is 3. Incidentally, FIG. 6 shows an example of a case where the travel plan A, the travel plan B, the highlight A, the highlight B, and the hotel A are displayed in this order.

Next, association of contents will be described. The processor 10 of the tabletop information processing apparatus 100 can associate displayed contents with each other. For example, when the attribute to enable association is defined as shown in FIG. 5, the processor 10 can associate the travel plans A and B with contents in which the kind attribute is highlight or hotel. Thus, the processor 10 performs such control that the travel plan A is associated with the highlight A and the hotel A and is displayed. On the other hand, the processor 10 controls so that content not defined to have the attribute to enable association is not associated. In this example, although whether or not association is performed is defined according to the kind of the content, the content name may be directly specified. For example, if the travel plan A includes the definition of “content name=highlight A”, although the processor 10 allows the travel plan A to be associated with the highlight A, the processor inhibits the travel plan A from being associated with the highlight B.

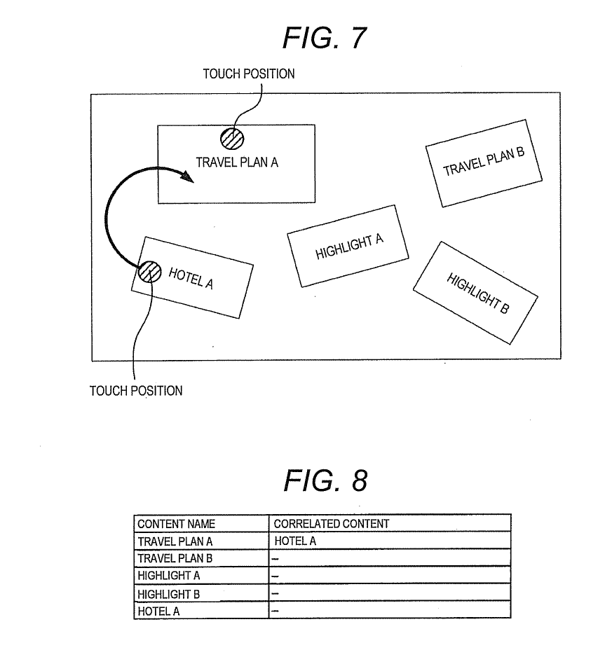

The operation of association will be described by use of FIG. 7. While the user touches and holds the travel plan A, the user touches the hotel A, and drags and drops it onto the travel plan A. Then, the operation of associating the hotel A with the travel plan A is performed. Incidentally, the operation of touching the travel plan A may be omitted. That is, the operation of bringing one of the plural images displayed on the touch panel display into contact with another image may be performed.

When the respective contents are displayed on the touch panel display 50, the processor 10 generates association information shown in FIG. 8 in the DRAM 40. Now, in order to associate the travel plan A with the hotel A, the processor renews the information of the travel plan A of the association information, and records that the hotel A is associated.

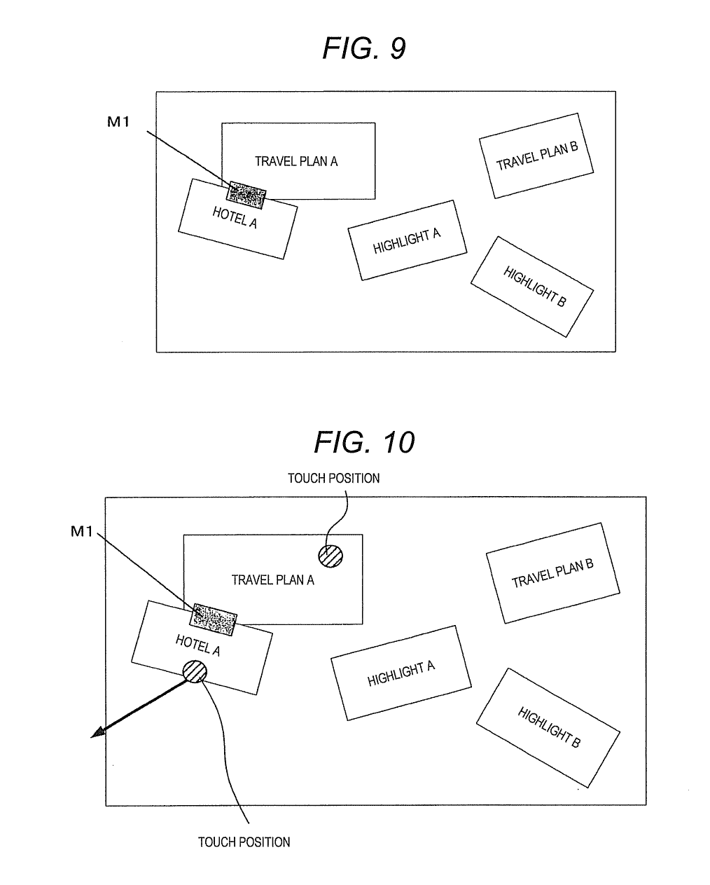

FIG. 9 shows a display example of the touch panel display 50 after the association is performed. The processor 10 controls the display of the touch panel display 50 so as to display a mark M1 indicating that the travel plan A and the hotel A are integrated and are associated. When such association is performed, the processor 10 controls so that these are integrally displayed and operated. For example, when the travel plan A is moved, the processor 10 performs display control so that the hotel A is also moved together. The same applies to the operation of rotation, selection, deletion, enlargement and reduction of the travel plane A, and the processor 10 controls the touch panel display 50 so that the hotel A is also rotated, selected, deleted, enlarged, and reduced together. Besides, when the hotel A is moved, rotated, enlarged or reduced, the processor 10 may perform display control so that the travel plan A is also moved, rotated, enlarged or reduced together.

Next, release of association will be described. The release of the associated contents is performed when the touch panel display 50 detects a user's release operation. An example of this operation will be described by use of FIG. 10. When the hotel A is moved to be separated from the travel plan A in the state where the travel plan A is touched and held, the association is released. The processor 10 releases the association on the display, and renews the association information shown in FIG. 8 so that the hotel A associated with the travel plan A is released.

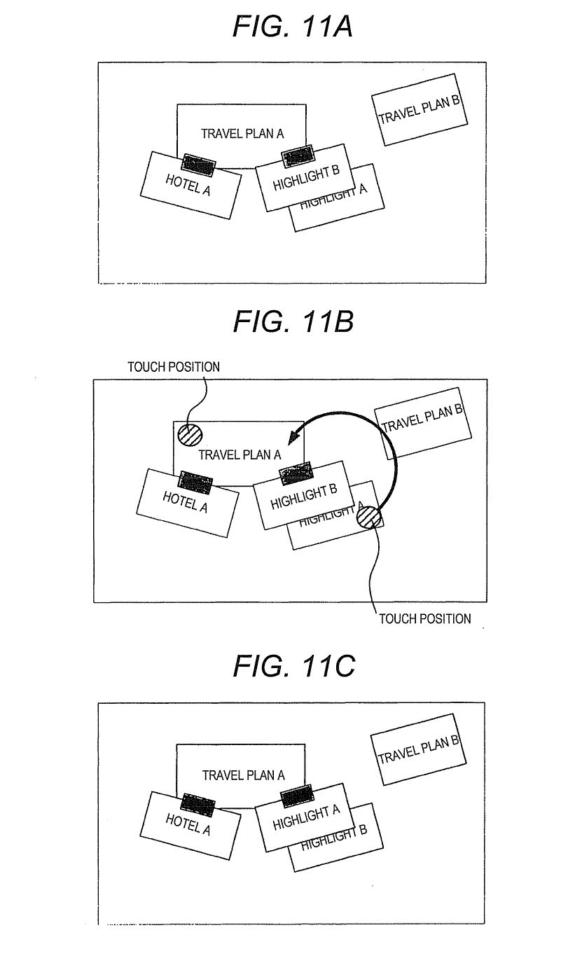

Next, content classification will be described. According to the content information of FIG. 5, the travel plan A can be associated with the hotel A, the highlight A, and the highlight B. At this time, as shown in FIG. 11A, the touch panel display 50 classifies and displays the contents according to the kind of the attribute. In FIG. 11A, the hotel A in which the kind of the attribute is the hotel, and the highlight A and the highlight B in which the kind of the attribute is the highlight are divided and displayed. The processor 10 controls so that contents having the same kind of attribute information are overlappingly displayed. Thus, the touch panel display 50 displays the respective contents so that the same kind of contents are collected and displayed, and different kind of contents are arranged to be separated from each other. In other words, the processor 10 controls the touch panel display 50, and the contents are displayed so that the distance between the different kind of contents is larger than the distance between the same kind of contents.

Next, display sorting of contents will be described. In FIG. 11A, the contents are classified and displayed according to the kind attribute, and are sorted and displayed according to the display order shown in FIG. 6. That is, the processor 10 controls so that a content with a large display order is located above on the display, and a content with a small display order is located below on the display. In FIG. 6, the display order of the highlight A is 3, while the display order of the highlight B is 4. The processor 10 controls the display of the touch panel display 50 in accordance with this display order, so that the highlight B and the highlight A are displayed in this order from the upper side.

Here, when the touch panel display 50 detects an operation exemplified in FIG. 11B, the processor 10 changes the display order. The change operation of the display order is performed such that in a state where the travel plan A is touched and held (the holding operation may be omitted), the highlight A, which is not at the uppermost layer and is partially displayed, is dragged and dropped onto the travel plan A. Then, the attribute information of FIG. 6 is renewed, and the display order of the highlight A becomes the largest value and becomes 5. On the other hand, the missing number occurring when the display order of the highlight A is changed is filled with another content. In this example, the processor 10 shifts the display order of the highlight B from present order 4 to 3, and shifts the display order of the hotel A from present 5 to 4.

When the display order is renewed by the touch operation in this way, the processor 10 controls the touch panel display 50 so that the highlight A associated with the travel plan is displayed in front of the highlight B (see FIG. 11C).

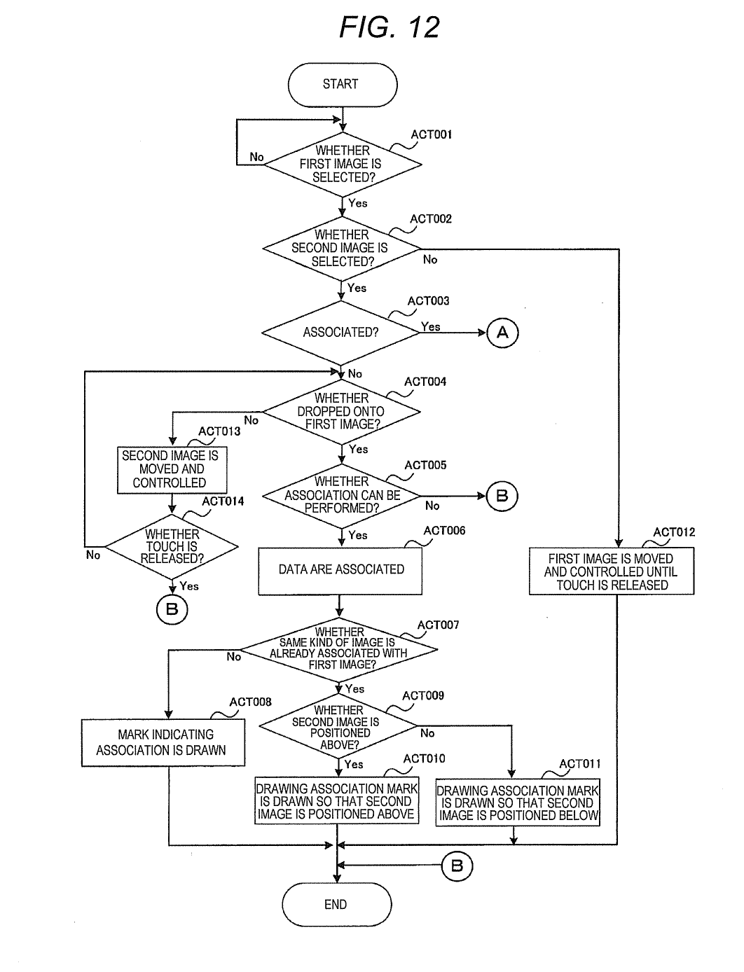

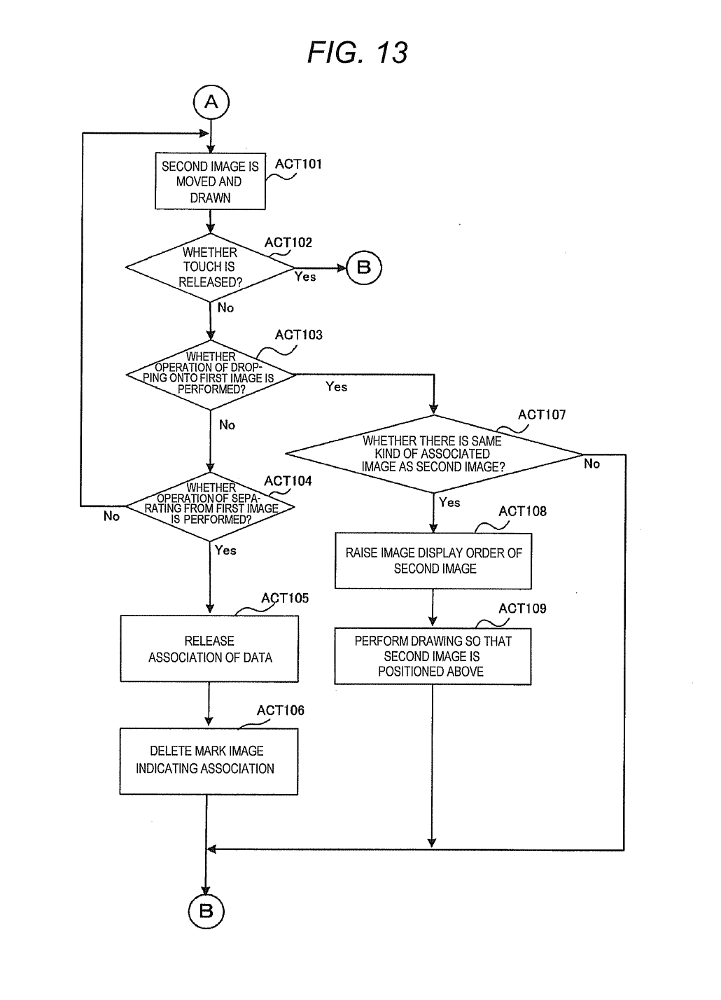

An operation example of the tabletop information processing apparatus 100 according to the embodiment will be described by use of flowcharts of FIG. 12 FIG. 13.

The processor 10 determines whether a content image is selected (ACT001). This is determined based on whether or not the touch panel display 50 detects touch of a fingertip or the like in an area where there is a content image. In this example, the content image selected at ACT001 is a first image. The processor 10 waits at this process until the content image is selected (ACT001, loop of No). If the image is selected (ACT001, Yes), the processor determines whether another content image is continuously selected in a specified time (ACT002). In this example, the content image selected at ACT002 is a second image.

If the second image is not selected in the specified time (ACT002, No), the processor 10 performs movement control so that the first image follows the movement of the fingertip until the finger touch is released (ACT012). The processor 10 refers to FIG. 8, and if there is another content image associated with the first image, the processor performs movement control so that these are integrally moved. Incidentally, here, although the movement control is performed, the display control of rotation, enlargement, reduction or the like may be performed in accordance with the operation details of the user.

If the second image is selected in the specified time at ACT002 (ACT002, Yes), the processor 10 refers to the data shown in FIG. 8 and determines whether the two images are already associated (ACT003). If associated, advance is made to the flowchart shown in FIG. 13. If not associated (ACT003, No), the processor 10 determines whether the second image is dropped on the first image (operation in which the second image contacts the first image, and the fingertip touch is released in the state) (ACT004). This is the determination as to whether or not the operation shown in FIG. 7 is performed. If not dropped on the first image (ACT004, No), the processor 10 moves and controls the second image (ACT0013). ACT004 and ACT013 are repeatedly performed (ACT014, loop of No) until the fingertip touch is released (ACT014, Yes) or until the second image is dropped on the first image (ACT004, Yes).

At ACT 004, if the second image is dropped on the first image (ACT004, Yes), the processor 10 refers to the data shown in FIG. 5, and determines whether or not the second image can be associated with the first image (ACT005). If the association is impossible (ACT005, No), the procedure is ended. If the association is possible (ACT005, Yes), the processor 10 renews the data shown in FIG. 8, and associates the second image with the first image (ACT006).

The processor 10 refers to the data of FIG. 8 and refers to the data of FIG. 5, and determines whether the same kind of image is already associated with the first image (ACT007) If there is no such image (ACT007, No), the processor 10 draws an association mark M1 between the first image and the second image (ACT008) and ends the procedure.

On the other hand, if the same kind of image is already associated (ACT007, Yes), the processor 10 acquires the display order of the existing image and the display order of the second image from the data shown in FIG. 6, and determines a magnitude relation therebetween (ACT009). If the display order of the second image is larger (ACT009, Yes), the processor 10 overlappingly draws the existing image and the second image so that the second image is located above, and displays the association mark M1 between the second image located at the uppermost surface and the first image (ACT010). If the display order of the second image is smaller (ACT009, No), the processor 10 draws so that the second image is located below (ACT011). Incidentally, at ACT011, if there is a space where the association mark M1 is drawn, the association mark M1 is drawn between the first image and the second image (ACT011).

Return is made to the description of the determination at ACT003. At ACT003, if the first image and the second image are associated (ACT003, Yes), advance is made to the flowchart shown in FIG. 13. The processor 10 performs movement control of the second image (ACT101). At this time, if the touch of the fingertip is released (ACT102, Yes), the procedure is ended. If the touch is maintained (ACT102, No), the processor 10 determines whether the second image is moved and is dropped on the first image (ACT103). This is the determination as to whether or not the operation shown in FIG. 11B is performed. If the drop operation is not performed (ACT103, No), the processor 10 continuously determines whether a separating operation between the first image and the second image is performed (ACT104). This is the determination as to whether or not the operation shown in FIG. 10 is performed. If the separating operation is not performed (ACT104, No), return is made to ACT101, and the process of ACT101 to ACT104 is repeatedly performed.

At ACT104, if the separating operation is performed, and the second image is separated from the display area of the first image and the contact is released (ACT104, Yes), the processor 10 releases the association in the data shown in FIG. 8 (ACT105), and deletes the display of the mark M1 indicating the association (ACT106).

On the other hand, at ACT103, if the operation of dropping the second image onto the first image is performed (ACT103, Yes), the processor 10 refers to the data shown in FIG. 5 and FIG. 8, and determines whether or not there is an image having the same kind as the second image and associated with the first image (ACT107). If there is such image (ACT107, Yes), the processor 10 changes the display order so that the display order of the second image becomes large in the data shown in FIG. 6 (ACT108). If a missing number occurs in the data shown in FIG. 6 by this operation, the processor 10 renews to fill the missing number. Incidentally, if the display order of the second image is larger (upper level), the data renewal of FIG. 6 may not be performed. The processor 10 controls drawing so that the second image is located at the uppermost layer (ACT109).

At ACT107, if there is no relevant image having the same kind as the second image (ACT107, No), the procedure is ended in this example.

In the flowcharts shown in FIG. 12 and FIG. 13, after the series of processes are performed, the end process is performed. However, actually, return is made to ACT001 and the procedure is repeatedly performed.

In the embodiment, although the tabletop information processing apparatus is described, no limitation is made to this. The embodiment can be applied to any computer with a touch panel display, such as a tablet computer.

The control unit corresponds to a configuration including at least the processor 10, the DRAM 20 and the communication bus B according to the embodiment. The program operating in cooperation with the hardware such as the processor 10, the DRAM 20 and the communication bus B is previously stored in the HDD 40 (or the ROM 30), and is loaded onto the DRAM 20 by the processor 10 and is operated. The storage unit corresponds to the DRAM 20 or the HDD 40 according to the embodiment. The first information corresponds to the kind of the attribute information shown in FIG. 5 according to the embodiment.

A program for causing a computer to execute the function described in the embodiment may be provided. This program may have any name such as a display control program, a user interface program, or a device control program.

In this embodiment, although the description is made on the case where the function to carry out the invention is previously recorded in the apparatus, no limitation is made to this. The same function may be downloaded from a network, or a recording medium storing the same function may be installed in the apparatus. As the recording medium, any recording medium, such as a CD-ROM, may be used as long as the program can be stored and can be read by the apparatus. Besides, the function previously installed or obtained by download may be such that the function is realized in cooperation with an OS (Operating System) in the apparatus.

As described above, according to the embodiment, scattering of display images can be suppressed.

The invention can be carried out in other various forms without departing from the sprit or the main features thereof. Thus, the embodiment is merely an example in all aspects and should not be interpreted as limitations. The scope of the invention is defined by the claims and is not restricted by the specification at all. Further, all modifications, various improvements, substitutions and alternations belonging to the equivalent scope of the claims are within the scope of the invention.

What is claimed is:

1. An information processing apparatus comprising:
a touch panel display; and
a control unit configured to perform a control in which when the touch panel display receives an operation of bringing one of a plurality of images displayed on the touch panel display into contact with another image, the two images are integrally displayed and are integrally operated.

2. The apparatus according to claim 1, wherein the control unit controls display of the touch panel display to display a mark, which indicates that the images are integrated, between the two images.

3. The apparatus according to claim 1, further comprising a storage unit that stores first information previously defined for each of the images displayed on the touch panel display, wherein
based on the first information stored in the storage unit, the control unit controls whether the two images are integrated.

4. The apparatus according to claim 3, wherein when the touch panel display further receives an operation of bring one of the plurality of displayed images into contact with the integrated another image, the control unit controls to integrate these images, and controls display of the touch panel display to overlappingly display images coincident to each other in the first information.

5. The apparatus according to claim 4, wherein if the touch panel display detects a touch in an image not located above among the overlappingly displayed images, and the touch position is moved to the another image, the control unit controls the display of the touch panel display and the touch detected image is located at an upper side of the overlap.

6. An information processing method for an apparatus includes a touch panel display, comprising:
detecting an operation of bringing one of a plurality of images displayed on the touch panel display into contact with another image; and
controlling, when the operation is detected, to integrally display the two images and to integrally operate the two images.

7. The method according to claim 6, wherein the control step controls display of the touch panel display to display a mark, which indicates that the images are integrated, between the two images.

8. The apparatus according to claim 6, further comprising storing first information previously defined for each of the images displayed on the touch panel display, wherein
based on the storing step, the control step controlling whether the two images are integrated.

9. The method according to claim 8, wherein when the touch panel display further receives an operation of bring one of the plurality of displayed images into contact with the integrated another image, the control step controlling to integrate these images, and controlling display of the touch panel display to overlappingly display images coincident to each other in the first information.

10. A computer-readable storage medium storing a program for causing a computer which includes a touch panel display to execute processing, comprising:
detecting an operation of bringing one of a plurality of images displayed on the touch panel display into contact with another image; and
controlling, when the operation is detected, to integrally display the two images and to integrally operate the two images.
